(19) United States
(12) Patent Application Publication
(10) Pub. No.: US 2022/0326497 A1
(43) Pub. Date: Oct. 13, 2022

(54) MICROSCOPE DUAL-USE LAMP DRAWER SET DEVICE

(71) Applicant: MOTIC CHINA GROUP CO., LTD., kiamen,Fujian (CN)

(72) Inventors: Wenjie Huang, Xiamen, Fujian (CN); Yuyan Zheng, Xiamen, Fujian (CN); Jingyun Zhuang, Xiamen, Fujian (CN)

(21) Appl. No.: 17/417,369

(22) PCT Filed: May 26, 2020
(86) PCT No.: PCT/CN2020/092234

§ 371 Date: Jun. 22, 2021

(30) Foreign Application Priority Data
Apr. 7, 2020 (CN) 202020484002.3

(51) Int. Cl. G02B 21/06; G02B 21/24

(52) U.S. Cl. CPC G02B 21/06; G02B 21/24

(57) ABSTRACT

A microscope dual-use lamp drawer set device is disclosed, including a microscope base, a lamp drawer set, a lamp source, a positive pin holder, a negative pin holder. The microscope base is provided with a groove, and the positive pin holder and the negative pin holder are installed in the groove. The lamp drawer set is mounted in the groove, the lamp source is mounted on the lamp drawer set. There are two positive pin holders in the groove of the microscope base, and four negative pins in the lamp drawer set. When the lamp drawer set is installed in a normal detection, the upper two negative pins are connected with the positive pin holders, and the halogen lamp is on. In reverse installation, the lower two negative pins are connected with the positive pin holders, and the LED light is on.

### TECHNICAL FIELD

The present disclosure relates to the technical field of microscope, in particular to a microscope dual-use lamp drawer set device.

### BACKGROUND

Under normal circumstances, the illumination source of the microscope is fixed, such as either an LED lamp source or a halogen lamp source. Due to the different uses of halogen lamps and LED lamp sources, users need to choose halogen lamp or LED lamp according to the actual situation, so the light source needs to be replaced. At the same time, due to the short life and the high replacement rate of the LED lamp source and the halogen lamp source, the replacement of the lamp source in the prior art also requires the disassembly of the frame and the objective table. The operation not only easily damages the frame and the objective table of the microscope, which causes great inconvenience to replace the microscope power supply, and but also affects the precision of the microscope due to the disassembly and assembly process. Although the use of the lamp drawer set in the prior art solves this problem to a certain extent, the drawer set in the prior art cannot realize the two-way use of the drawer set. When replacing the light source, the drawer set needs to be replaced at the same time, and the labor cost and material cost are high.

For example, the prior art (Patent CN1790088A) discloses an illumination lamp assembly for a microscope. The microscope has a microscope stand which includes a female member containing a first electrical socket terminal. The first electrical socket terminal is used to provide power for the illumination lamp, and the female socket is located in the microscope; a male member, wherein the male member includes at least two electrical pin terminals for mating and engagement with the first electrical socket terminal and receiving current therefrom; and a second electrical socket terminal connected to at least two electrical pin terminals and receiving current therefrom, the second electrical socket terminal is used to fix the illumination lamp and deliver current to it. However, this technology can only be used for fixed-directional sockets to supply power, and cannot achieve bi-directional plug-in power supply, which has limitations.

For example, the prior art (Patent CN1938627A) discloses an illumination unit for an optical instrument, which is arranged in or on the microscope stand, and can easily replace the existing light-emitting mechanism. For the lighting unit used for optical instruments, especially microscopes, the lamp holder and the light-emitting mechanism are arranged on a drawer-like insertion body, which can be inserted into a separate housing or the base housing of the optical instrument, and make the light-emitting mechanism correspond to the optical axis orientation in the insertion body. The insertion body has an electrical connection mechanism for an independent power source or a power source of an optical instrument, and has elements for connecting the control box/or adjusting the light-emitting mechanism. On the one hand, a defective light-emitting mechanism can be quickly replaced by the illumination unit without any problems. On the other hand, the lighting conditions can be changed in a simple manner by replacing the entire insertion body, and other light emitting mechanisms and/or other optical components can be used in the insertion body. It is easy to see from the content of the present disclosure and the drawings in the prior art that the insertion body has a fixed direction in this design, and it cannot be used if the direction is changed, which has limitations.

### SUMMARY

The objective of the present disclosure is to provide a microscope dual-use lamp drawer set device, which aims to make the lamp drawer set easy to dual-use with simple, convenient and low cost, double the service life, and the microscope dual-use lamp drawer set device can use both LED lamp source and halogen lamp source.

In order to solve the above problem, a microscope dual-use lamp drawer set device is provided by the present disclosure, including a microscope base, a lamp drawer set, a lamp source, a positive pin holder, a negative pin holder, the microscope base is provided with a groove, the positive pin holder and the negative pin holder are installed in the groove; the lamp drawer set is mounted in the groove, the lamp source is mounted on the lamp drawer set.

There are two of the positive pin holders, the two positive pin holders are a positive pin holder 1 and a positive pin holder 2, the positive pin holder 1 and the positive pin holder 2 are arranged in the same straight line, the distance between the positive pin holder 1 and the positive pin holder 2 is 52 mm, and the distance between the positive pin holder 1 or the positive pin holder 2 and the edge of the microscope base is 36.5 mm.

The positive pin holder 1 is provided with two holes, the two holes are the proximal hole and the distal hole, and a distance between the proximal hole and the distal hole is 7.5 mm.

The proximal hole is matched with an LED negative pin, and the distal hole is matched with a halogen lamp negative pin.

The positive pin holder 2 is provided with a hole, the hold is matched with the negative pin.

The lamp drawer set is provided with an LED lamp source and a halogen lamp source, the two lamp sources are respectively provided with two negative pins, the negative pins are respectively located on the upper side and the lower side of the drawer set, and the negative pins are fixed on the drawer set with screws through the pin holders.

When the lamp drawer set is installed in a normal direction, the upper two negative pins are respectively connected with the distal hole of the positive pin holder 1 and the hole on the positive pin holder 2, and the halogen lamp source works; when the lamp drawer set is installed in a reversed direction, the lower two negative pins are respectively connected with the proximal hole of the positive pin holder 1 and the hole on the positive pin holder 2, and the LED lamp source works.

The lamp drawer set is provided with a handle. The lamp drawer set can be pulled out through the handle no matter whether the drawer set is installed in normal or reverse.

The lamp drawer set is provided with a rotatable elastic pin, when the lamp drawer set is installed in a normal direction, the rotatable elastic pin is rotated to protrude from a bottom of the lamp drawer set and lock the microscope base; when the lamp drawer set is installed in a reversed direction, the other side of the rotatable elastic pin locks the microscope base to prevent the lamp drawer set from falling out.

Due to the different uses of halogen lamps and LED light sources, the user can choose to use halogen lamps or LED lamps according to the actual situation:

Halogen lamp: The spectrum is relatively long, close to sunlight, which is more realistic for observation. However, halogen lamps generally have a short life. And LED lamp: the price is cheaper than the halogen lamp, the service life is relatively longer, the brightness is very high, and it can be seen clearly in the field of vision. However, the LED light is a single-wavelength light, which will be distorted in many cases. Besides, the LED light emits the white light, it is harmful to the eyes.

However, the lamp drawer set of the present disclosure is provided with two light sources, namely a halogen lamp and an LED lamp, and the user can switch between the LED lamp and the halogen lamp through the direct installation and the reverse installation, so as to meet different needs.

In the prior art patents such as: Patent CN1790088A discloses an illumination lamp assembly for a microscope. The microscope has a microscope stand which includes a female member containing a first electrical socket terminal. The first electrical socket terminal is used to provide power for the illumination lamp, and the female socket is located in the microscope; a male member, wherein the male member includes at least two electrical pin terminals for mating and engagement with the first electrical socket terminal and receiving current therefrom; and a second electrical socket terminal connected to at least two electrical pin terminals and receiving current therefrom, the second electrical socket terminal is used to fix the illumination lamp and deliver current to it. However, this technology can only be used for fixed-directional sockets to supply power, and cannot achieve bi-directional plug-in power supply, which has limitations.

Further, Patent CN1938627A discloses an illumination unit for an optical instrument, which is arranged in or on the microscope stand, and can easily replace the existing light-emitting mechanism. For the lighting unit used for optical instruments, especially microscopes, the lamp holder and the light-emitting mechanism are arranged on a drawer-like insertion body, which can be inserted into a separate housing or the base housing of the optical instrument, and make the light-emitting mechanism correspond to the optical axis orientation in the insertion body. The insertion body has an electrical connection mechanism for an independent power source or a power source of an optical instrument, and has elements for connecting the control box/or adjusting the light-emitting mechanism. On the one hand, a defective light-emitting mechanism can be quickly replaced by the illumination unit without any problems. On the other hand, the lighting conditions can be changed in a simple manner by replacing the entire insertion body, and other light emitting mechanisms and/or other optical components can be used in the insertion body. It is easy to see from the content of the present disclosure and the drawings in the prior art that the insertion body has a fixed direction in this design, and it cannot be used if the direction is changed, which has limitations.

The present disclosure compared with the microscope illumination light source device in the prior art has the advantages in simple structure, easy operation, the doubled service life. And it has a high versatility due to the same shape and structure, which is suitable for any similar microscope with built-in light source to illuminate the object to be detected. In addition to the above advantages, the present disclosure can also achieve the two directions use of the drawer set, greatly improving the use rate and cost savings.

### BRIEF DESCRIPTION OF THE DRAWINGS

The present disclosure can be further illustrated by the non-limiting embodiments with the given drawings;

FIG. 1 is an overall exploded view of the microscope dual-use lamp drawer set device of a specific embodiment of the present disclosure when it is being installed normally;

FIG. 2 is an overall exploded view of the microscope dual-use lamp drawer set device of the specific embodiment of the present disclosure when it being installed reversely;

FIG. 3 is an assembly diagram of the microscope and dual-use lamp drawer set used in the specific embodiment of the present disclosure;

FIG. 4 is a perspective view of the front and back sides of the lamp drawer set used in the specific embodiment of the present disclosure;

FIG. 5 is a perspective view of the rotatable elastic pin of the lamp drawer set used in the specific embodiment of the present disclosure.

### DETAILED DESCRIPTION OF THE EMBODIMENTS

In order to enable those skilled in the art to better understand the present present disclosure, the technical solution of the present present disclosure will be further described below with reference to the accompanying drawings and embodiments.

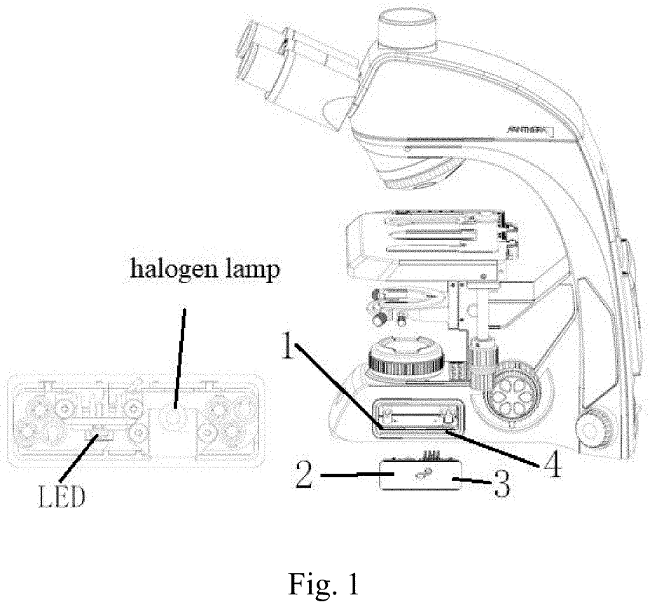

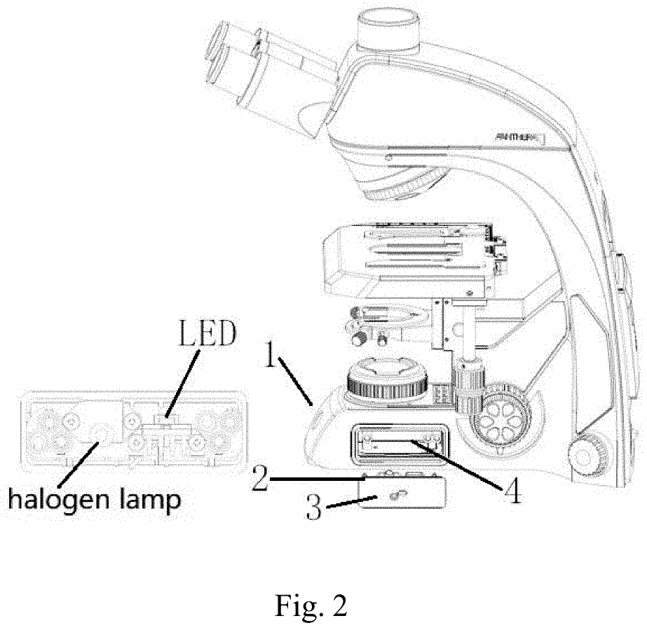

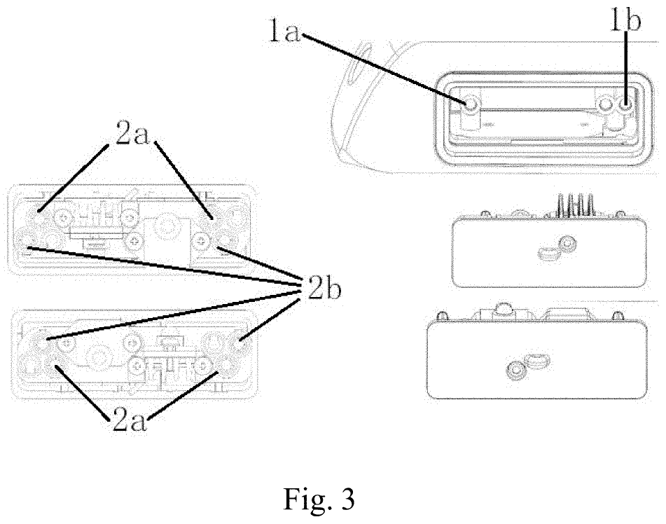

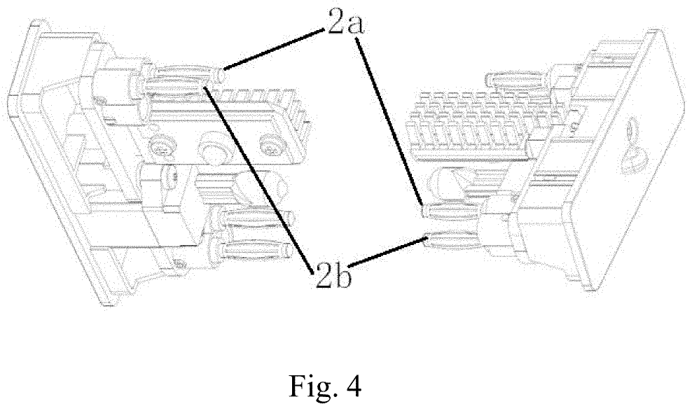

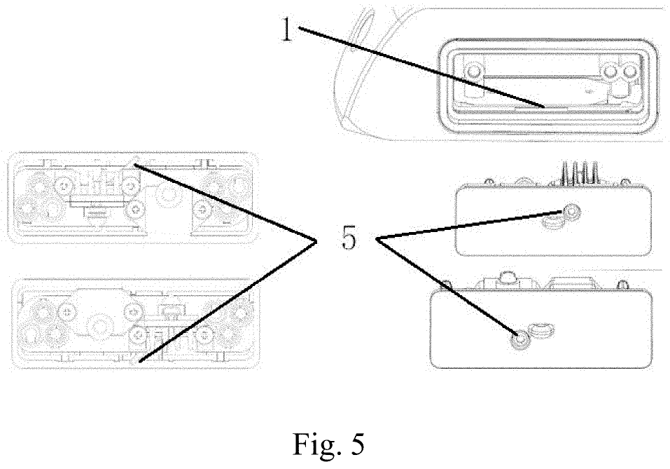

As shown in FIG. 1 to FIG. 5, the implementation of the technical solution of the present disclosure includes: a microscope base 1, a lamp drawer set 2, an LED lamp source 2c, a halogen lamp source 2d, and a positive pin holder 1a, a positive pin holder 1b, an upper negative pin holder 2a, a lower negative pin holder 2b, a handle 3, a groove 4, and a pin 5. The microscope base is provided with the groove 4, and the positive pin holders 1a, 1b are installed in the groove 4, the lamp drawer set 2 is installed with four negative pins 2a, 2b. The lamp drawer set 2 is installed in the groove 4. The LED light source 2c and the halogen lamp source 2d is installed on the lamp drawer set 2.

The positive pin holder 1a is provided with two holes, namely a proximal hole and a distal hole.

The proximal hole is matched with the LED negative pin 2a, and the distal hole is matched with a halogen lamp negative pin 2b.

The positive pin holder 1b is provided with a hole which matches with the negative pin.

The lamp drawer set 2 is provided with an LED lamp source and a halogen lamp lamp source, and the two lamp sources are respectively provided with two negative pins: 2a, 2b. The negative pin 2a is the two negative pins on the upper side of the lamp drawer set, the negative pin 2b is the two negative pins on the lower side of the lamp drawer set, and the negative pins are fixed on the drawer set 2 with screws through the pin holder.

When the drawer set is installed in normal direction, two of the upper negative pins 2a are respectively connected with the distal hole of the positive pin holder 1a and the hole on the positive pin holder 1b, so that the halogen lamp source 2d works. And when the drawer set is installed in reversed direction, two of the lower negative pins 2b are respectively connected with the proximal hole of the positive pin holder 1a and the hole on the positive pin holder 1b, so that the LED light source 2c works.

The lamp drawer set 2 is provided with a handle 3, and the lamp drawer set 2 can be pulled out through the handle 3 whether the drawer set 2 is installed normal or reversed.

The lamp drawer set 2 is provided with a rotatable elastic pin 5. When the lamp drawer set 2 is installed in a normal direction, the pin 5 is rotated to protrude from the bottom, so as to lock the microscope base. When the lamp drawer set 2 is installed in a reversed direction, the other side of the pin 5 locks the microscope base 1 to prevent the lamp drawer set 2 from falling off.

Due to the different uses of halogen lamps and LED light sources, the user can choose to use halogen lamps or LED lamps according to the actual situation:

Halogen lamp: The spectrum is relatively long, close to sunlight, which is more realistic for observation. However, halogen lamps generally have a short life. And LED lamp: the price is cheaper than the halogen lamp, the service life is relatively longer, the brightness is very high, and it can be seen clearly in the field of vision. However, the LED light is a single-wavelength light, which will be distorted in many cases. Besides, the LED light emits the white light, it is harmful to the eyes.

However, the lamp drawer set of the present disclosure is provided with two light sources, a halogen lamp and an LED lamp, and the user can switch between the LED lamp and the halogen lamp through the direct installation and the reverse installation, so as to meet different needs.

The present disclosure has the advantages in strong practical functions, simple structure, convenient operation, low cost, etc., and it has a high versatility due to the same shape and structure.

A detailed introduction to the microscope dual-use lamp drawer set device provided by the present present disclosure is described above. It can be realized that the microscope can be used simply, conveniently, and at low cost to make the lamp drawer set dual-use easily, and the service life is doubled. It can use both the LED lamp source and the halogen lamp source, with the same appearance and strong versatility. The description of the embodiments is only used to help understand the method and core idea of the present present disclosure. It should be pointed out that for those of ordinary skill in the art, without departing from the principle of the present disclosure, several improvements and modifications can be made to the present disclosure, and these improvements and modifications are also within the scope of the claims of the present disclosure.

What is claimed is:

1. A microscope dual-use lamp drawer set device, comprising a microscope base, a lamp drawer set, a lamp source, a positive pin holder, a negative pin holder, the microscope base is provided with a groove, the positive pin holder and the negative pin holder are installed in the groove; the lamp drawer set is mounted in the groove, the lamp source is mounted on the lamp drawer set.

2. The microscope dual-use lamp drawer set device according to claim 1, wherein there are two of the positive pin holders, the two positive pin holders are a positive pin holder 1 and a positive pin holder 2, the positive pin holder 1 and the positive pin holder 2 are arranged in the same straight line, a distance between the positive pin holder 1 and the positive pin holder 2 is 52 mm, and a distance between the positive pin holder 1 or the positive pin holder 2 and an edge of the microscope base is 36.5 mm.

3. The microscope dual-use lamp drawer set device according to claim 1, wherein the positive pin holder 1 is provided with two holes, the two holes are the proximal hole and the distal hole, and a distance between the proximal hole and the distal hole is 7.5 mm.

4. The microscope dual-use lamp drawer set device according to claim 1, wherein the proximal hole is matched with an LED negative pin, and the distal hole is matched with a halogen lamp negative pin.

5. The microscope dual-use lamp drawer set device according to claim 1, wherein the positive pin holder 2 is provided with a hole, the hold is matched with the negative pin.

6. The microscope dual-use lamp drawer set device according to claim 1, wherein the lamp drawer set is provided with an LED lamp source and a halogen lamp source, the two lamp sources are respectively provided with two negative pins, the negative pins are respectively located on an upper side and a lower side of the drawer set, and the negative pins are fixed on the drawer set with screws through the pin holders.

7. The microscope dual-use lamp drawer set device according to claim 1, wherein when the lamp drawer set is installed in a normal direction, the upper two negative pins are respectively connected with the distal hole of the positive pin holder 1 and the hole on the positive pin holder 2, and the halogen lamp source works; when the lamp drawer set is installed in a reversed direction, the lower two negative pins are respectively connected with the proximal hole of the positive pin holder 1 and the hole on the positive pin holder 2, and the LED lamp source works.

8. The microscope dual-use lamp drawer set device according to claim 1, wherein the lamp drawer set is provided with a handle.

9. The microscope dual-use lamp drawer set device according to claim 1, wherein the lamp drawer set is provided with a rotatable elastic pin; when the lamp drawer set is installed in a normal direction, the rotatable elastic pin is rotated to protrude from a bottom of the lamp drawer set and lock the microscope base at the lower side; when the lamp drawer set is installed in a reversed direction, the other side of the rotatable elastic pin locks the microscope base to prevent the lamp drawer set from pulling out.
